(19) United States
(12) Patent Application Publication
(10) Pub. No.: US 2007/0195960 A1
(43) Pub. Date: Aug. 23, 2007

(54) Apparatus and method for encrypting data

(75) Inventors: Jeffrey A. Goldman, Newbury Park, CA (US); Thanh A. Diep, Houston, TX (US)

Correspondence Address: STEPTOE & JOHNSON LLP, 1330 CONNECTICUT AVENUE, N.W., WASHINGTON, DC, 20036, US

(73) Assignee: General Dynamics Advanced Information Systems, Ypsilanti, MI (US)

(21) Appl. No.: 11/411,038

(22) Filed: Apr. 26, 2006

Related U.S. Application Data
(63) Continuation of application No. 10/122,017, filed on Apr. 12, 2002, now abandoned.

(51) Int. Cl. H04L 9/00

(52) U.S. Cl. 380/286

(57) ABSTRACT

A method for sharing a data set including multiple classifications of security between one or more entities and/or between one or more organizations. Public-keys for use in selectively encrypting the data set with multiple classifications of security are made available in a public-key table. A private-key corresponding to the public-key is used to decrypt the selectively encrypted data set. Public-keys available in the public-key table are re-used to selectively encrypt data sets as appropriate. Public/private-key pairs also may be generated as needed for use in encrypting a document with multiple classifications of security. A single data set may be further encrypted with additional classifications of security as needed. A data set thus may be made available to various entities and/or organizations over a common repository. Symmetric and other encryption techniques also may be used.

### BACKGROUND OF THE INVENTION

1. Field of the Invention

The present invention relates generally to data encryption, and more specifically to an apparatus and method for providing access to a data set that includes one or more classifications of security between one or more entities and/or organizations without compromising the content of the data set.

2. Description of the Related Art

The use of computers to store and exchange information has expanded rapidly in recent years. With this expanding use of computers, the need to restrict access to certain information that is stored in or exchanged between computers likewise has expanded. Various encryption techniques currently are used to restrict access to such information. Among these encryption techniques are public-key encryption (also referred to as “asymmetric” encryption) and private-key encryption (also referred to as “symmetric” encryption). Public-key encryption uses a public/private-key combination. The public-key is used to encrypt information that only can be decrypted by the entity in possession of the corresponding private-key. The public-key is disseminated to the various entities who desire to encrypt information to be decrypted by the corresponding private-key. Private-key encryption uses a single private-key to encrypt and decrypt information. Asymmetric encryption techniques typically are preferred over symmetric techniques because there is less risk of the private-key becoming compromised and used in an unauthorized manner.

The efficient sharing of information containing multiple classifications of security between one or more entities and/or within or between one or more organizations presents several problems previously unsolved. There exists a continuing need for an efficient way to share information containing multiple classifications of security with other entities in a timely fashion. The typical use of a centralized entity in charge of encrypting such information generally results in delayed dissemination of such information. Furthermore, the recipient of such information typically cannot further disseminate such information to additional entities without the involvement of the centralized entity in charge of encrypting such information. There likewise exists a continuing need to provide additional measures of security to protect information containing multiples classifications of security when such information is disseminated to entities with varying classifications of security clearance.

There also exists a continuing need for an efficient way of disseminating a data set including multiple classifications of security between entities and/or organizations. When sharing information between entities and/or organizations, a new data set typically is generated that omits the information that should not be accessed by the receiving entity and/or organization. Furthermore, the process of sharing information between entities and/or organizations typically is delayed by the use of a centralized entity responsible for reviewing the information to be shared.

### SUMMARY OF THE INVENTION

The present invention overcomes the foregoing and other limitations by providing a method for the efficient sharing of information containing multiple classifications of security between one or more entities as well as within or between one or more organizations. In one embodiment, the present invention allows any entity with access to a public-key table or other appropriate repository to maintain public-keys (referred to herein as a “public-key table”) to selectively encrypt a data set using one or more existing public-keys or to generate a new public/private-key pair as desired to be used for encrypting the data set. The use of existing public-keys eliminates the need to generate a new (and duplicative) public/private-key pair each time that information including multiple classifications of security will be disseminated to one or more entities. The ability of any entity with access to the public-key table to generate a new public/private-key pair as desired without the involvement of a centralized entity further allows for the efficient dissemination of information selectively encrypted using multiple classifications of security.

The present invention further provides the capability to encrypt a single data set with multiple classifications of security for use by one or more intended recipients having different security clearance classifications. The capability of such recipients to access the same encrypted data set eliminates the need to generate separate data sets for use by the such recipients. In addition, once such a data set has been encrypted with multiple classifications of security, the data set can be made available to the one or more intended recipients in a common repository such as a computer network. This eliminates the need to store information for use by multiple recipients having varying classifications of security clearance on separate networks or other appropriate data repositories.

The present invention further provides added security to a data set including multiple classifications of security by making the encrypted portions of the data set “transparent” to entities that do not have the corresponding private-key to decrypt such portions. Accordingly, entities without the private-key necessary to decrypt portions of the data set may be unaware that such encrypted portions are present in the data set.

The present invention is appropriate for use in any application where information including multiple classifications of security is to be shared between one or more entities and/or organizations. Such applications include, without limitation, government, military, and intelligence applications. Such applications further include health care, newsgathering, and any other businesses or other applications where information including multiple classifications of security is to be shared.

### BRIEF DESCRIPTION OF THE DRAWINGS

FIGS. 1-4 are schematic diagrams of various embodiments for generating compartments according to the present invention; and

FIGS. 5-11 illustrate various embodiments for encrypting a data set with multiple classifications of security according to the present invention.

### DETAILED DESCRIPTION OF THE PREFERRED EMBODIMENT

1. Compartment Generation

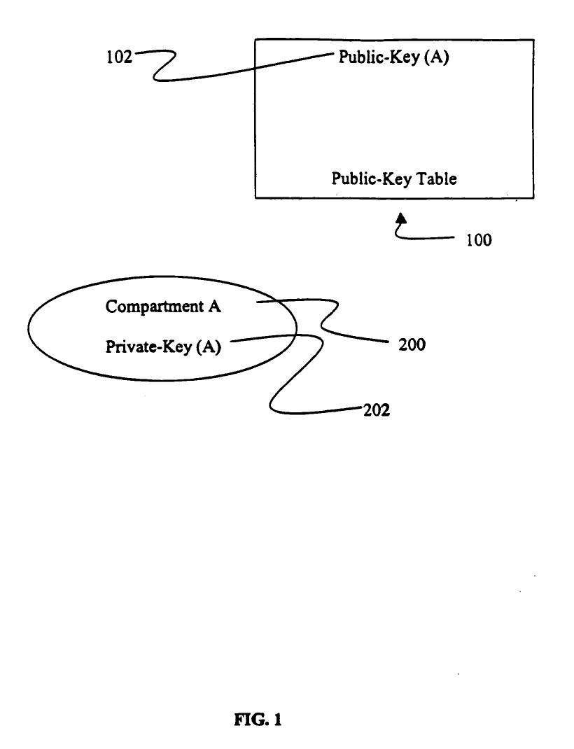

FIG. 1 illustrates an embodiment of the present invention wherein entities that have access to a public-key table 100 may use public-key encryption techniques to encrypt and distribute information to intended recipients. In a preferred embodiment, a public-key table 100 is used to maintain one or more public-keys that are used for encrypting information. In addition to public-key table 100, any other implementation suitable for storing public-keys may be used according to the present invention. An entity (hereinafter “distributing entity”) that desires to make encrypted information available to other entities (hereinafter “receiving entities”) defines the receiving entities by generating a “compartment” that includes all of the receiving entities. The term “compartment” refers to a group of entities that share a common private-key used to decrypt information encrypted using a corresponding public-key. The distributing entity typically creates a public-key and corresponding private-key using any appropriate public/private-key generation technique. In a preferred embodiment, the technique used to generate the public-key and private-key is an RSA based system. In addition, any technique suitable for generating public/private-keys pairs may be used. Such techniques include, without limitation, elliptical curve-based systems and discrete logarithm-based systems.

The distributing entity then provides a name to be associated with the public-key. The public-key is displayed along with its name in a public-key table 100. The name associated with the public-key can, but need not, be the name of the compartment that will receive information encrypted with the public-key. FIG. 1 illustrates a public-key 102 named “A” because public-key 102 will be used to encrypt information that will be decrypted by the entities that comprise Compartment A 200. In another embodiment, the public-key can be given a name that does not reveal the identity of the entities that comprise the compartment. In this embodiment, only the entities that comprise the compartment (and other designated entities, if appropriate) will know which entities comprise the compartment that receives information encrypted using the public-key. In this embodiment, a message encrypted using the public-key providing the identities of the entities comprising the compartment associated with the public-key is sent to the entities comprising the compartment.

The private-key that corresponds to the public-key is distributed to the entities that comprise the compartment. Referring to FIG. 1, a private-key 202 corresponding to a public-key 102 is distributed to the entities comprising Compartment A 200. The entities comprising Compartment A 200 may then use private-key 202 to decrypt information that is encrypted using public-key 102. The various methods for distributing the private-keys are discussed in detail below. The various methods used to store and maintain the private-keys likewise are discussed in detail below.

In situations where the distributing entity is generating a public-key and corresponding private-key so that only the distributing entity will use the private-key to decrypt information (i.e., the distributing entity is generating a compartment comprised only of the distributing entity), there is no need to distribute the private-key because it already will be in the possession of the distributing entity.

The following is an example of how the present invention could be used by governmental intelligence organizations. Here, the director of the National Security Administration (“NSA”) desires to distribute encrypted information for use by only those members of the NSA who have “Secret” security clearance. The director first creates a public-key 102 and corresponding private-key 202 and names public-key 102 “NSA SECRET.” The director then makes public-key 102 available in a public-key table 100 that is accessible to all members of the NSA and other designated organizations as appropriate. The private-key 202 corresponding to public-key 102 is distributed to all entities within the NSA who have Secret clearance, thereby forming a “compartment” comprising all entities within the NSA who have Secret security clearance.

Once private-key 202 has been distributed to the entities comprising the compartment (here, all entities within the NSA who have Secret security clearance), the director (or any entity with access to public-key table 100) can distribute encrypted information to all entities within the NSA having Secret security clearance using public-key 102 named “NSA SECRET” (available in public-key table 100) to encrypt the information and then distributing the encrypted information using any appropriate method. For example, the encrypted information can be sent using an email message including the encrypted information to all entities within the NSA, regardless of security clearance classification, or otherwise making the encrypted information available at a location accessible to all entities within the NSA regardless of security clearance classification. Only those entities having the appropriate private-key (i.e., the private-key corresponding to NSA SECRET public-key 102) can decrypt the encrypted content of the message.

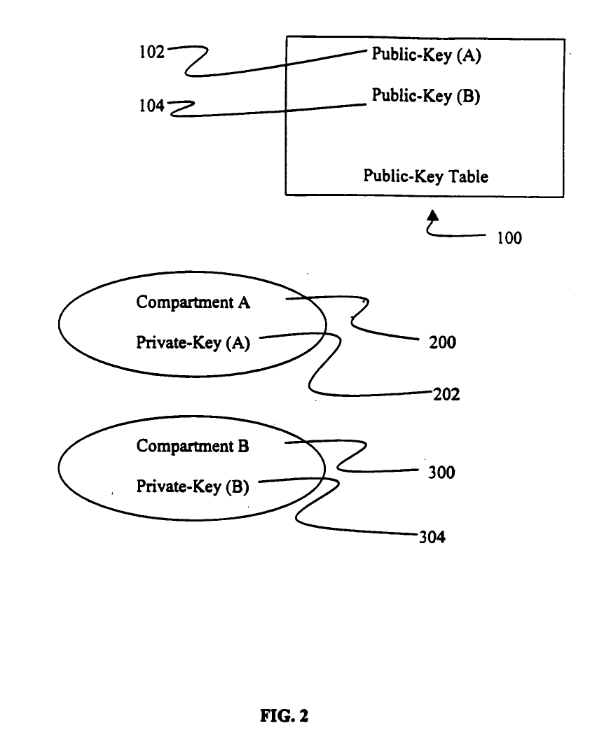

FIG. 2 illustrates a further embodiment of the present invention wherein a new compartment is generated. Here, a public-key 104 and private-key 304 are generated to distribute encrypted information for use by those entities comprising Compartment B 300. Public-key 104 is named “B” herein for illustration because it is used to distribute encrypted information that can be decrypted only by the entities comprising Compartment B 300, but any other desired name may be used. One or more of the entities that comprise Compartment A 200 may also be part of Compartment B 300 and vice versa. Entities common to both compartments would possess both private-key (A) 202 and private-key (B) 304. Further entities may be added to Compartment A 200 by providing such entities with private-key (A) 202, and further entities may be added to Compartment B 300 by providing such entities with private-key (B) 304.

Continuing with the foregoing government intelligence example, the director of the NSA also desires to provide information for use by all members of the Central Intelligence Agency (“CIA”) having Secret security clearance. The director refers to public-key table 100 and determines that a public-key has not yet been generated for use in encrypting information for members of the CIA having Secret security clearance. The director creates a private-key 304 and corresponding public-key 104 and names public-key 104 “CIA SECRET.” The director then makes public-key 104 available in public-key table 100, which is accessible to all members of the NSA, CIA, and other organizations or entities as desired. Private-key 304 corresponding to public-key 104 is distributed to all members of the CIA with Secret security clearance, thus creating a “compartment” comprising all members of the CIA with Secret security clearance.

Any entity with access to public-key table 100 now may distribute encrypted information to all members of the CIA with Secret security clearance by encrypting the appropriate information using public-key 104, which is named CIA SECRET. As discussed in further detail below, a data set, document, or other collection of data may be encrypted using both public-key 102 (named NSA SECRET) and public-key 104 (named CIA SECRET), thus allowing for the efficient encryption of information using different security classifications. Here, only certain portions of a document might be directed only to those members of the NSA with Secret security clearance, while other portions might be directed only to those members of the CIA with Secret security clearance. According to the present invention (and as further discussed below), portions of a single document directed to one group of intended recipients can be encrypted using public-key 102, while other portions directed to another group can be encrypted using public-key 104. The single document thus encrypted can be made available to both groups for subsequent decryption, thus eliminating the need to generate two separate documents. The portions encrypted using public-key 102 can only be decrypted by the entities having private-key 202, and the portions encrypted with public-key 104 can only be decrypted by entities having private-key 304.

FIG. 3 illustrates a further embodiment wherein a public-key for use by two existing compartments is generated. When a distributing entity desires to distribute encrypted information to all of the entities comprising Compartment A 200 and to all of the entities comprising Compartment B 300, the distributing entity can generate a public-key 106 for use by all entities comprising both compartments rather than encrypting the information twice (i.e., encrypting once using public-key (A) 102 and encrypting a second time using public-key (B) 104). The distributing party typically would first reference public-key table 100 to determine if a public-key already exists for use in encrypting the information to be distributed to all of the entities comprising Compartment A 200 and to all of the entities Compartment B 300. If such a key does not exist, the distributing entity would generate a private-key 206 and corresponding public-key 106 named “A, B.” Private-key 206 is distributed to all of the entities comprising Compartment A 200 and to all of the entities comprising Compartment B 300.

A single set of data may now be encrypted using three different public-keys (i.e., public-key 102, public-key 104, and public-key 106). Thus, portions of a data set only for use by Compartment A can be encrypted with public-key 102, portions of the data set only for use by Compartment B can be encrypted using public-key 104, and portions of the data set for use by both Compartment A and Compartment B can be encrypted using public-key 106. Only an entity that possesses all three corresponding private-keys (i.e., private-key 202, private-key 304, and private-key 206) will be able to decrypt information that is encrypted with all three public-keys. The encryption of a single data set using multiple public-keys is discussed in detail below.

Continuing with the government intelligence example, the director of the NSA now desires to provide information to all members of the NSA with Secret security clearance and all members of the CIA with Secret security clearance. The director refers to public-key table 100 and determines that a public-key has not been generated for use in distributing encrypted information to all members of the NSA with Secret security clearance and all members of the CIA with Secret security clearance. The director generates a public-key 106 and names it “NSA & CIA SECRET” and makes this public-key available in public-key table 100. Private-key 206 corresponding to public-key 106 is distributed to all members of the NSA with Secret security clearance and all members of the CIA with Secret security clearance.

Any entity with access to public-key table 100 may now use public-key 106 (named NSA & CIA SECRET) to encrypt information that only may be decrypted by members of the NSA with Secret clearance and members of the CIA with Secret security clearance (provided such entities possess private-key 206). Only the entities that possess private-key 206 can decrypt information that is encrypted using public-key 106. Accordingly, a member of either the NSA or CIA who has Secret security clearance but for some reason does not possess private-key 206 is unable to decrypt information that is encrypted using public-key 106.

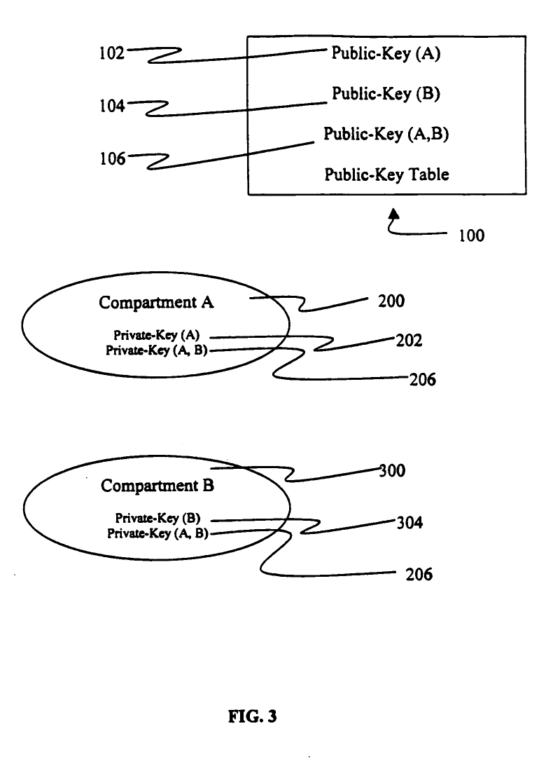

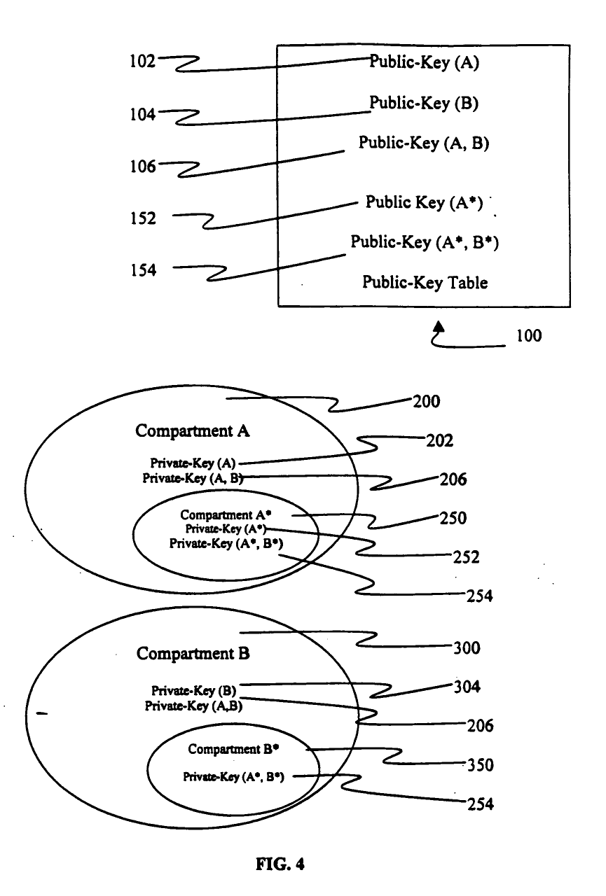

FIG. 4 illustrates a further embodiment of the present invention wherein a public-key and corresponding private-key are generated for use in encrypting information for distribution to a subset of the entities comprising an existing compartment. A distributing entity that desires to encrypt information that can only be decrypted by certain entities (shown as Compartment A* 250) within Compartment A 200 will refer to public-key table 100 to determine whether a public-key for use in encrypting information to be decrypted by the desired entities already exists. If such a public-key is not available in public-key table 100, the distributing entity will generate a public-key 152 named, for example, “A*” 152 and a corresponding private-key 252 and make public-key A* 152 available in public-key table 100. Private-key 252 is distributed to the entities comprising Compartment A* 250.

FIG. 4 also illustrates a further embodiment of the present invention wherein a public-key and corresponding private-key are generated for use in encrypting information for distribution to a sub-set of the entities within two or more existing compartments. When a distributing entity desires to encrypt information that only can be decrypted by the entities comprising Compartment A* and a sub-set of the entities comprising Compartment B 300 (shown as Compartment B* 350), the distributing entity again refers to public-key table 100 to determine whether a public-key for use in encrypting information that can be decrypted by the appropriate entities exists. If such a public-key does not exist, the distributing entity generates a public-key 154 named “A*, B*” and a corresponding private-key 254 and makes public-key A*, B* 154 available in public-key table 100. Private-key 254 is distributed to the entities comprising Compartment A* 250 and Compartment B* 350. Any entity with access to public-key table 100 may use public-key A*, B* 154 to encrypt information that can be decrypted by the entities comprising Compartment A* 250 and Compartment B* 250.

Continuing with the above government intelligence example, the NSA director now desires to provide certain encrypted information to all members of the NSA with “Top Secret” security clearance and likewise to share certain other encrypted information with all member of the NSA with Top Secret security clearance and all members of the CIA with “Top Secret” security clearance. The director refers to public-key table 100 to determine whether a public-key already exists for encrypting information that can be decrypted by members of the NSA with Top Secret security clearance. Because such a public-key does not exist, the director generates a public-key 152 and corresponding private-key 252 and names public-key 152 “NSA TOP SECRET.” Private-key 252 is distributed to the members of the NSA with Top Secret security clearance.

The director then refers to public-key table 100 to determine whether a public-key already exists for encrypting information that can be decrypted by members of the NSA with Top Secret security clearance and members of the CIA with Top Secret security clearance. Because such a public-key does not exist, the director generates a public-key 154 and corresponding private-key 254 and names public-key 154 “NSA & CIA TOP SECRET.” Private-key 154 is distributed to all members of the NSA with Top Secret security clearance and to all members of the CIA with Top Secret security clearance.

Any entity with access to public-key table 100 now may use public-key 152 (named NSA TOP SECRET) to encrypt information that can be decrypted by members of the NSA with Top Secret security clearance (because such members possess private-key 252, which corresponds to public-key 152). Note that information encrypted using public-key 102 (named NSA SECRET) cannot be decrypted by members of the NSA with Top Secret security clearance unless these members also possess private-key 202 (which corresponds to public-key 102).

Any entity with access to public-key table 100 likewise may now use public-key 154 (named NSA & CIA TOP SECRET) to encrypt information that can be decrypted by members of the NSA with Top Secret clearance and members of the CIA with Top Secret security clearance (because such members possess private-key 254, which corresponds to public-key 154). A single set of data may now be encrypted so that certain portions may only be decrypted by NSA members with Secret security clearance (by using public-key 102 to encrypt), certain portions may only be decrypted by members of the CIA with Secret security clearance (by using public-key 104 to encrypt), and certain portions may only be decrypted by members of the CIA with top security clearance and members of the NSA with Top Secret security clearance (by using public-key 154 to encrypt). Such an encryption technique provides for the efficient sharing of encrypted information both within an organization and between organizations because a data set only needs to be encrypted once using the appropriate public-keys.

The foregoing examples and illustrations as provided in FIGS. 1-4 are not intended to limit the present invention. A compartment can be created according to the present invention that comprises any combination of entities, regardless of the organization, if any, to which such entities belong. Note that for N separate compartments, up to 2^{N}−1 private/public-key combinations could be generated so that any combination of compartments may share encrypted information (assuming that a private/public-key combination for any compartment or combination of compartments is not duplicated). Thus, an entity that can decrypt all information encrypted according to the present invention could possess up to 2^{N}−1 private-keys (assuming that a private/public-key combination for any compartment or combination of compartments is not duplicated).

In addition, use of the present invention is not limited to governmental, military, or intelligence applications, as it may be used in any application where the encryption of information is desired. For example, the present invention may be used by businesses engaged in partner relationship management (“PRM”) applications where one entity desires to share encrypted information with certain other entities. The present invention likewise may be used in any other application where encrypted information is shared between entities, such as health care applications.

a Distributing Private-Keys

Once a distributing entity has generated a public/private-key pair, the keys may be distributed (if needed) to the entities comprising the compartment that corresponds to the public/private-key combination in any appropriate manner. In a preferred embodiment of the present invention, the private-keys are distributed to the appropriate entities using the “Diffie-Hellman” key distribution scheme. As would be known to those skilled in the art, various other methods may be used for distributing the private-keys as well.

In another embodiment, the private-keys could be distributed by encrypting the private-keys to be distributed using one or more public-keys available from the public-key table that correspond to the one or more compartments comprised of the entities who are to receive the private-keys being distributed. In this embodiment, the entity distributing the keys would refer to the public-key table and determine whether one or more public-keys exist that correspond to one or more compartments that comprise only the entities who are to receive the private-keys being distributed. If such one or more public-keys exist, these public-keys would be used to encrypt and distribute the private-keys.

b. Storing Keys

A receiving entity may use any appropriate means to store its private-keys. In a preferred embodiment, hardware technologies that encode private-keys onto a hardware device may be used to store the private-keys. Such hardware technologies include, without limitation, “Fortezza Cards” and “Clipper Chips” that are used to store the private-keys in hardware associated with the receiving entity's computer. Any other method suitable for storing private-keys likewise may be used.

In addition to the foregoing technologies for storing the private-keys, other biometric security technologies may be used to provide an additional layer of security associated with storing the private-keys. Such technologies include, without limitation, cornea scans, retina scans, fingerprint identification, and voice authentication.

2. Encrypting Data with Multiple Security Classifications

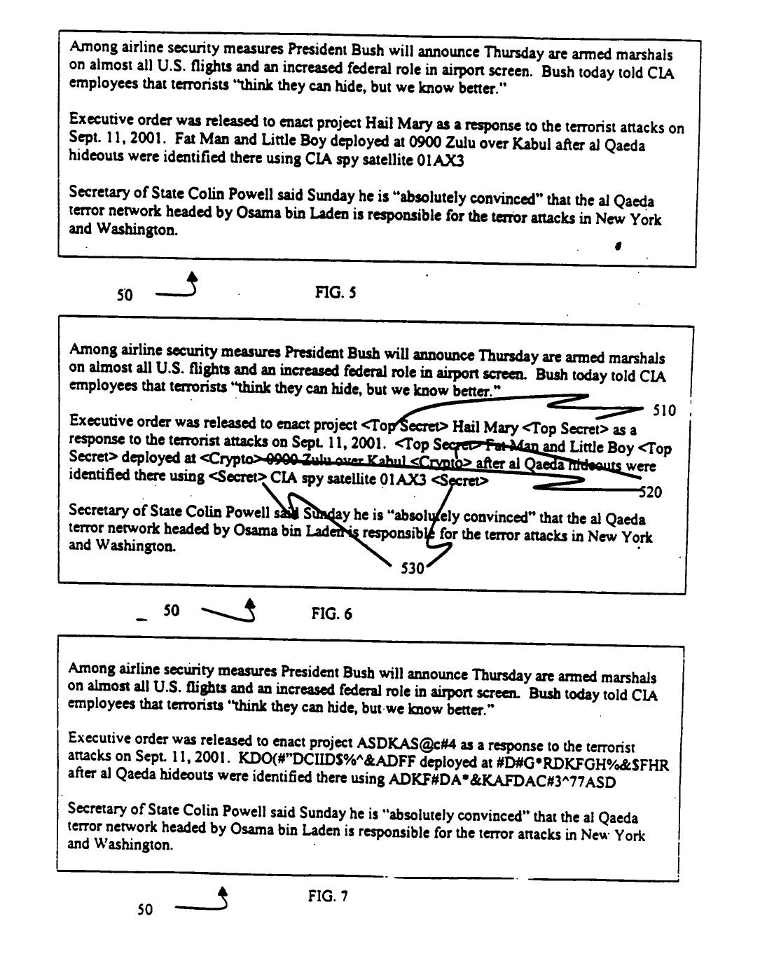

Another aspect of the present invention is the capability to encrypt a data set, document, or other collection of data or information (referred to herein as a “document” or “data set”) with multiple classifications of security. In this manner, certain portions of the document content can be selectively encrypted, leaving the remaining document content unencrypted. As an alternative to leaving portions of the document unencrypted, such portions of the document may be encrypted using a public-key corresponding to a private-key possessed by the entities who will have access to such content. The content of a single document likewise can be encrypted with multiple security classifications for use by multiple entities without compromising the content of the document. In addition, a document encrypted with multiple classifications of security can be maintained on a single network or other suitable repository rather than maintaining the document on multiple discrete networks or other locations based on the security classification of the document's content. This is accomplished by encrypting the content of the document using public-keys that correspond to the compartment that has security clearance to view such content. A document may be encrypted at any level, down to the data element level. Thus, a document may be encrypted at the page, paragraph, word, or any other appropriate level. A document typically is encrypted according to the present invention by inserting “tags” (or any other suitable means for encrypting the content of a document) that correspond to a public-key around the portions of a document that are to be encrypted. FIGS. 5-11 further illustrate this aspect of the present invention.

FIG. 5 illustrates an example of a document 50 that includes content associated with various security clearance classifications. The content within a document such as document 50 typically is reviewed by an analyst or any other entity responsible for preserving the security of the content of a document (referred to herein as an “analyst”) according to various security classifications before releasing the document to one or more various entities. The analyst typically will encrypt one or more portions of the document content according to the security classification associated with such portions. Thus, various portions of a document's content may be encrypted at various security classifications. In addition, one or more portions of a document's content may be encrypted so that entities from multiple organizations (e.g., the NSA and CIA) can decrypt one or more portions of a single document's content.

FIG. 6 illustrates document 50 as shown in FIG. 5 after an analyst has inserted the appropriate tags around certain portions of document 50's content so that such portions can be encrypted according to the security classification associated with such portions. Once the analyst has identified the one or more security classifications associated with the content of document 50, individual portions of document 50 can be selectively encrypted. Document 50 is selectively encrypted by identifying those specific portions of document 50 to be encrypted and inserting around those portions tags associated with the portion's security classification (i.e., the security classification associated with the public/private-key pair to be used for encrypting content that can only be decrypted by the entities comprising the appropriate compartment). FIG. 6 illustrates certain portions of document 50 encrypted at three different security classifications. The highest classification of security in this document is “Crypto.” Crypto tags 520 surround the content that needs to be maintained at the Crypto classification. Only the entities comprising the compartment with “Crypto” security clearance (Le., those entities that possess the private-key that can be used to decrypt the content encrypted with the public-key associated with the Crypto tag) can decrypt the content surrounded by Crypto tags 520. Document 50 also has content that is to be maintained at the Top Secret security classification. This is accomplished by inserting Top Secret tags 510 around such content. Finally, document 50 has content that is to be maintained at the Secret security classification. This is accomplished by inserting Secret tags 530 around such content. According to the present invention, an entity only can decrypt those portions of document 50 that are encrypted using a public-key (i.e., surrounded by tags associated with the public-key) to which the entity has the corresponding private-key. Accordingly, only an entity possessing the private-keys that correspond to each of the public-keys associated with Crypto tags 520, Top Secret tags 510, and Secret tags 530 can view the entire content of document 50.

FIG. 7 illustrates what a fully encrypted document 50 looks like to an entity that does not possess any private-keys that correspond to the public-keys used to encrypt document 50. The encrypted portions of document 50 are not viewable to the entity and appear to be a random selection of alpha-numeric characters. Additionally, the encryption tags embedded in the encrypted document 50 are not viewable to this entity. Therefore, in this embodiment, an entity reviewing document 50 without any applicable private-keys will not know how document 50 has been encrypted nor the security classifications at which document 50 is encrypted.

FIG. 8 illustrates an example of what document 50 would look like to an entity that possesses the “Secret” private-key. The portions of document 50 encrypted with the Top Secret and Crypto public-keys are not viewable to this entity, nor are the classifications at which these portions are encrypted revealed. The portion 540 of document 50 encrypted using Secret tags 530 is decrypted using the entity's corresponding private-key, and the entity would likewise see that this portion was encrypted using Secret tag 530.

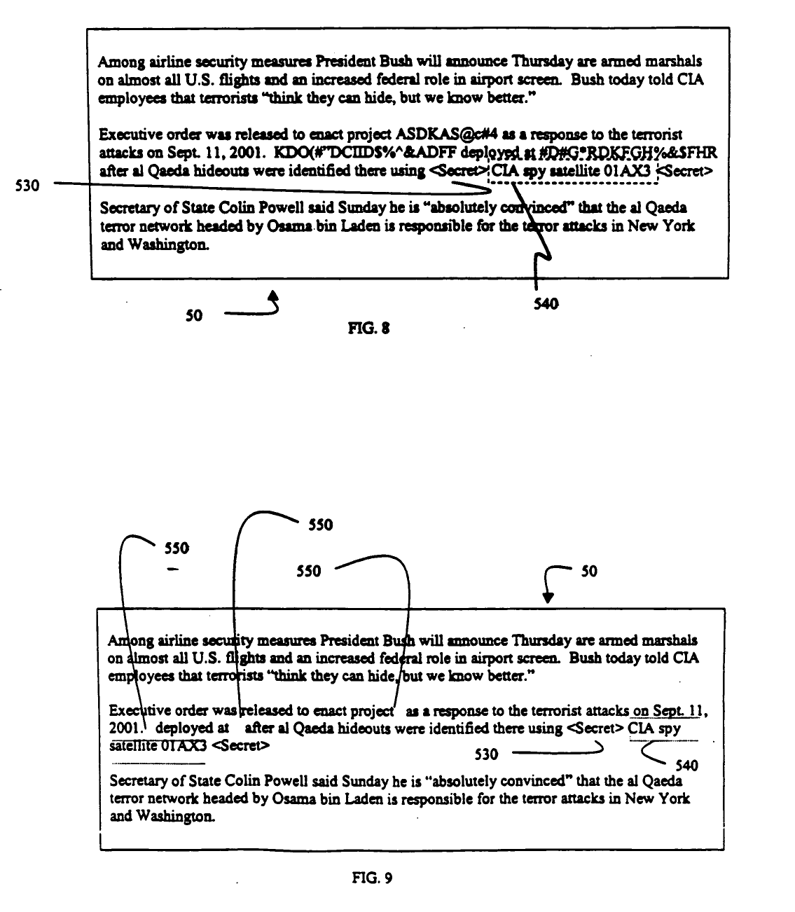

FIG. 9 illustrates an alternate method for displaying document 50 encrypted using tags for which an entity does not have the corresponding private-key. Here, document 50 is tagged as shown in FIG. 6. FIG. 9 illustrates how document 50, according to this embodiment, would appear to an entity possessing only the Secret private-key. The Secret private-key decrypts the portion 540 of document 50 encrypted using the Secret public-key. It also displays the Secret tags 530 showing where the “Secret” encryption was performed. Unlike in FIG. 8, the areas 550 that are encrypted at other security classifications are blanked out, and there is no reference to other encryption within document 50. Thus, the entity viewing document 50 would not know that information encrypted using the Top Secret and Crypto tags is present in document 50.

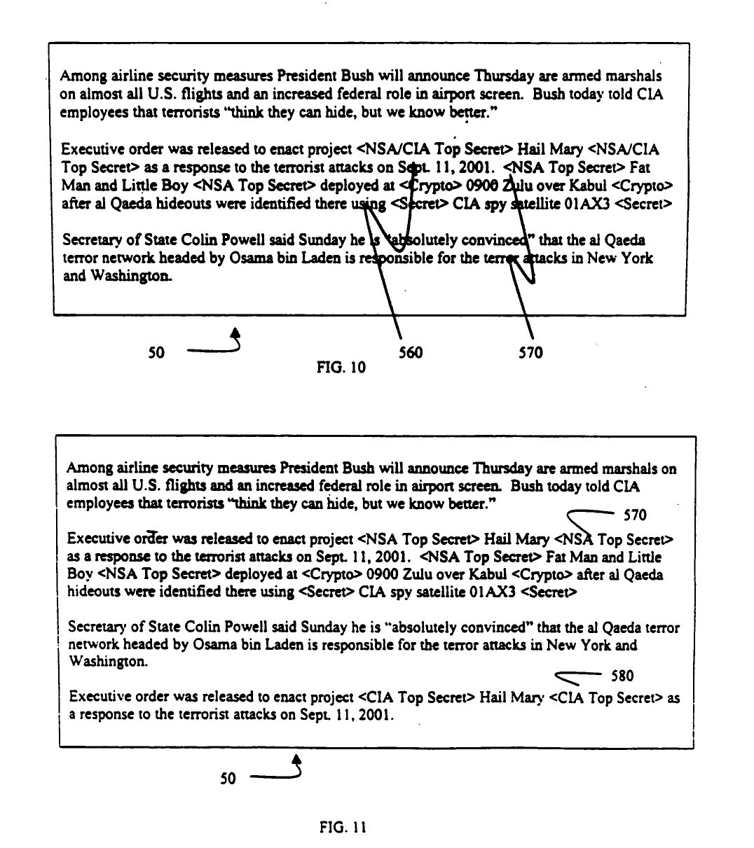

Another aspect of the present invention is the capability for various entities from the same or different organizations to have access to the same encrypted document. These various entities all may be able to access certain portions of the encrypted document while other portions may only be accessible to certain entities. In the following example, the same document 50 shown in FIG. 5 is used within the NSA. In this example, document 50 has two portions that are encrypted to a Top Secret classification within the NSA. Certain Top Secret information within document 50 also must be disclosed to the CIA. FIG. 10 illustrates one way to perform this task. Here, the two Top Secret portions are tagged differently. The information to be shared with the CIA is tagged with an NSA/CIA Top Secret tag 560 while the other set of information that is to remain internal to the NSA is tagged with an NSA Top Secret tag 570. Only those entities with the private-keys corresponding to NSA Top Secret and NSA/CIA Top Secret would be able to view both encrypted portions of document 50. A member of the CIA who possesses the NSA/CIA Top Secret private-key would be able to access only the information tagged with the NSA/CIA Top Secret tag. This CIA member would not be able to decrypt the portion of document 50 encrypted using NSA Top Secret tag 570.

FIG. 11 illustrates an alternate embodiment to perform the above example. Here, the Top Secret portions of document 50 that are to be made available to the NSA and CIA are tagged twice. The Top Secret portions that are available to the NSA are tagged using NSA Top Secret tag 570. The Top Secret portion that is to be made available to the CIA is copied to another part of document 50 and coded with a CIA Top Secret tag 580. Use of NSA Top Secret tag 570 permits entities within the NSA who are entitled to access Top Secret information to view such information using only one private-key. In addition, entities within the CIA who possess the private-key then can decrypt content encoded with CIA Top Secret tag 580 and will be unaware that additional information encoded with NSA Top Secret tag 570 also is present in document 50.

The foregoing examples provide the preferred embodiment for encrypting a document with multiple classifications of security according to the present invention. However, any appropriate technique for encrypting the content of a document with multiple classifications of security may be used. Such techniques include, without limitation, embedding, layering, or nesting one classification of security within another classification (e.g., encrypting portions more than once).

The foregoing examples are not intended to limit the present invention, as data may be encrypted using keys or other encryption devices that correspond to any compartment or other group of entities, regardless of whether such entities correspond to any specific organization or hierarchical structure.

The foregoing method of encrypting a data set with multiple classifications of security also may be practiced using symmetric encryption techniques. Here, the one or more keys used to encrypt the document content could correspond to one or more tags used to encode the content, and the entities who will use the encrypted content (i.e., the entities comprising the compartment) possess the key used to decrypt the encrypted content. In this embodiment, a directory or other repository can be used to disclose the one or more compartments that have corresponding keys (the keys themselves are not disclosed in the directory). Use of such a directory can minimize the generation of duplicate keys for use with a common compartment. In addition to the foregoing, any other technique suitable for encrypting data also may be used.

Whereas the present invention has been described with respect to specific embodiments thereof, it will be understood that various changes and modifications will be suggested to one skilled in the art, and it is intended that the invention encompass such changes and modifications as fall within the scope of the appended claims.

1. A method for encryption, comprising:
defining a first compartment comprised of one or more entities;
selectively encrypting one or more first portions of a data set using a first key;
distributing to the one or more entities comprising the first compartment the first key and/or at least one key corresponding to the first key for use in decrypting the encrypted first portions; and
making the data set with the one or more selectively encrypted first portions available in a common repository,
wherein the foregoing steps are carried out by any entity with access to the common repository.

2-69. (canceled)
